(19) United States
(12) Patent Application Publication
(10) Pub. No.: US 2009/0160437 A1
(43) Pub. Date: Jun. 25, 2009

(54) Eddy Current Probe And Method Of Manufacture Thereof

(75) Inventor: Gary Kroner, Allison Park, PA (US)

Correspondence Address: THE WEBB LAW FIRM, P.C., 700 KOPPERS BUILDING, 436 SEVENTH AVENUE, PITTSBURGH, PA, 15219, US

(73) Assignee: CARBON STEEL INSPECTION, INC., Pittsburgh, PA (US)

(21) Appl. No.: 12/325,404

(22) Filed: Dec. 1, 2008

Related U.S. Application Data
(60) Provisional application No. 61/015,717, filed on Dec. 21, 2007.

(51) Int. Cl. G01N 27/90; H01F 41/06

(52) U.S. Cl. 324/240; 29/605

(57) ABSTRACT

Disclosed is an eddy current probe that includes a plurality of kidney-shaped coils disposed in end-to-end relation about an axis of an elongated body. An inner radius of each kidney-shaped coil faces the axis. An outer radius of each kidney-shaped coil faces away from the axis. A plurality of wires is provided, each of which is connected to one of the ends of one of the kidney-shaped coils via an opening in the body that runs inside the body from one end of the body to a position intermediate the one end of the body and the kidney-shaped coils. Also, disclosed is a method of making the eddy current probe including a method of forming each kidney-shaped coil.

### CROSS REFERENCE TO RELATED APPLICATION

This application claims benefit of U.S. Provisional Patent Application No. 61/015,717, entitled “Eddy Current Probe and Method of Manufacture Thereof”, filed Dec. 21, 2007, which is hereby incorporated by reference in its entirety.

### BACKGROUND OF THE INVENTION

1. Field of the Invention

The present invention relates to eddy current probes for inspection of tubes or other cylindrical components and, more particularly, to probes for providing defect signals which may be distinguished from noise signals.

2. Description of Related Art

Conventional eddy current probes have been found useful for detecting flaws and defects in tubes, pipes or other cylindrical components. Examples of prior art eddy current probes are disclosed in U.S. Pat. No. 4,608,534 to Cecco et al.; U.S. Pat. No. 4,808,927 to Cecco et al.; U.S. Pat. No. 4,742,298 to Ando et al.; U.S. Pat. No. 4,806,863 to White; U.S. Pat. No. 4,649,343 to Birchak et al.; and U.S. Pat. No. 4,808,924 to Cecco et al.

While prior eddy current probes are capable of detecting where along the length of a tube, pipe or other cylindrical component a flaw or defect may exist, heretofore, these prior art eddy current probes are not effective for pinpointing the location of the flaw or defect in the circumference of the tube, pipe or other cylindrical component.

In order to overcome these deficiencies of prior art eddy current probes, an eddy current probe was developed by the inventor of the present application that enables the identification of flaws or defects in a pipe, tube or other cylindrical component along its length and circumference. This eddy current probe is disclosed in U.S. Pat. No. 7,295,004 to Kroner. The eddy current probe disclosed in this patent includes a plurality of deformable substrates installed in a housing. These flexible substrates, however, are difficult to wind one or more coils of wire about and are difficult to insert into a slot in a housing of the eddy current probe during assembly thereof. Moreover, these flexible substrates limit the size of the probe that can be manufactured due to the substrates themselves taking up space.

Accordingly, a need exists for an eddy current probe and a method of manufacturing such an eddy current probe that overcomes the above-described problems. Still other problems the present invention overcomes will become apparent to those of ordinary skill in the art upon reading and understanding the following detailed description.

### SUMMARY OF THE INVENTION

The present invention is directed to an eddy current probe that includes an elongated body defining a longitudinal axis, a plurality of coils and a printed circuit board mounted in a recess in said elongated body. At least one circumferential slot is formed in the elongated body intermediate the ends of said elongated body. Each circumferential slot faces away from the longitudinal axis. Each coil defines an axis about which an interior surface of the coil defines an arcuate shaped central aperture of the coil and about which axis an exterior surface of the coil defines an arcuate shaped inner radius and an arcuate shaped outer radius. The arcuate shaped inner radius and the arcuate shaped outer radius of each coil extend between opposite ends of the coil. Each coil is mounted in the slot with the inner radius of the coil facing the longitudinal axis of the elongated body, with the outer radius of the coil facing away from the longitudinal axis of the elongated body. The plurality of coils are mounted in end-to-end relation in the slot. The printed circuit board is operative as an interface for connecting the ends of each coil to sensing circuitry.

The elongated body may be formed from an electrically and magnetically non-conductive material. The eddy current probe may further include a cover covering the elongated body and the plurality of coils mounted thereon. The cover may be formed from a magnetically non-conductive material.

The present invention is also directed to a method of making an eddy current probe. The method includes the steps of: (a) providing an elongated body that defines a longitudinal axis and which includes at least one circumferential slot intermediate the ends of the elongated body that faces away from the longitudinal axis; (b) providing a bobbin shaper having first and second arcuate surfaces positioned in spaced relation to define an arcuate gap therebetween and the bobbin shaper is operative for changing a distance between the first and second arcuate surfaces; (c) for each of a plurality of bobbins that defines a longitudinal axis, winding magnet wire on the bobbin around the longitudinal axis; (d) for each bobbin with magnet wire wound thereon positioned between the first and second arcuate surfaces of the bobbin shaper, causing the first and second arcuate surfaces to move together and deform the bobbin with magnet wire wound thereon into a kidney-shaped coil of wire about the longitudinal axis of the bobbin; and (e) mounting each kidney-shaped coil of wire in the circumferential slot of the body in end-to-end relation, with an inner radius of each kidney-shaped coil of wire facing into the slot and with the outer radius thereof facing away from the slot.

The method can further include connecting the ends of each kidney-shaped coil of wire to sensing circuitry, either directly or via a printed circuit board disposed in a recess in the elongated body.

The method can further include inserting the elongated body with the kidney-shaped coils of wire mounted thereon into a cover. The cover may be formed from a magnetically non-conductive material, and the elongated body may be formed from an electrically and magnetically non-conductive material.

The present invention is also an eddy current probe that includes a plurality of kidney-shaped coils disposed in end-to-end relation about an axis of an elongated body, with an inner radius of each kidney-shaped coil facing the axis and with an outer radius of each kidney-shaped coil facing away from the axis. The probe includes a plurality of wires. Each of the wires is connected to one of the ends of one of the kidney-shaped coils via an opening in the body that runs inside the body from one end of the body to a position intermediate the one end of the body and the kidney-shaped coils.

A side wall of the body has a reduced circumference where the end of the opening opposite the one end of the body is located. The eddy current probe may further include a printed circuit board mounted on the elongated body with the ends of each kidney-shaped coil connected thereto, with the one end of each wire connected to the corresponding end of one of the kidney-shaped coils of wire via the printed circuit board. The printed circuit board may be operative as an interface for connecting the ends of each coil to sensing circuitry. The eddy current probe may also further include a cover covering the body and the plurality of kidney-shaped coils disposed thereon. The cover may be formed from a magnetically non-conductive material, and the body may be formed from an electrically and magnetically non-conductive material.

These and other features and characteristics of the present invention, as well as the methods of operation and functions of the related elements of structures and the combination of parts and economies of manufacture will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an” and “the” include plural referents unless the context clearly dictates otherwise.

### BRIEF DESCRIPTION OF THE DRAWINGS

FIG. 1 shows an eddy current probe in accordance with the present invention;

FIG. 2 shows a kidney-shaped coil of wire for use with the eddy current probe of FIG. 1;

FIG. 3 is a flow chart of a method of manufacturing the eddy current probe of FIG. 1;

FIG. 4 shows the equipment used to wind a strand of magnetic wire on a bobbin to form a coil in accordance with the method of the present invention;

FIGS. 5A and 5B show a top portion of a bobbin shaper and a top plan view of a bottom portion of the bobbin shaper, respectively, used to shape the coil of magnetic wire into a kidney shape in accordance with the method of the present invention;

FIG. 5C shows the bottom portion of the bobbin shaper with a bobbin having a coil of magnetic wire positioned therein in accordance with the method of the present invention;

FIG. 5D shows the bobbin shaper with the top portion assembled to the bottom portion in accordance with the method of the present invention;

FIGS. 6A-6C show the bobbin shaper during various stages of operation;

FIG. 7 is a portion of the top plan view of the eddy current probe of FIG. 1 enlarged for magnification purposes;

FIG. 8 is a side view showing the eddy current probe of FIGS. 1 and 7 inserted in a cover and further showing insertion of the eddy current probe in accordance with the present invention into a tube to be tested thereby;

FIG. 9 is a mixed block diagram and circuit schematic view of an exemplary test system that is operative with the eddy current probe shown in FIG. 8 for detecting the presence of flaws in a tube under test; and

FIG. 10 shows another embodiment of an eddy current probe in accordance with the present invention.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

With reference to FIG. 1, an eddy current probe 1 includes an elongated body 3 defining a longitudinal axis X, two sets of kidney-shaped coils of wire 5, 5′ mounted on elongated body 3 and at least one printed circuit board (PCB) 7 mounted in a recess 9 in elongated body 3. A pair of circumferential slots 11, 11′ for receiving kidney-shaped coils of wire 5, 5′, respectively, is formed in elongated body 3 intermediate the ends of elongated body 3. Circumferential slot 11 supports the first set of kidney-shaped coils of wire 5 while slot 11′ supports the second set of kidney-shaped coils of wire 5′. The circumferential slots 11, 11′ face away from longitudinal axis X. Parallel to longitudinal axis X, each coil of wire 5 is aligned with a corresponding coil of wire 5′ thereby forming a coil of wire pair that are connected to the same Wheatstone Bridge 87 (discussed hereinafter) for sensing a flaw or defect in a tube, pipe, etc.

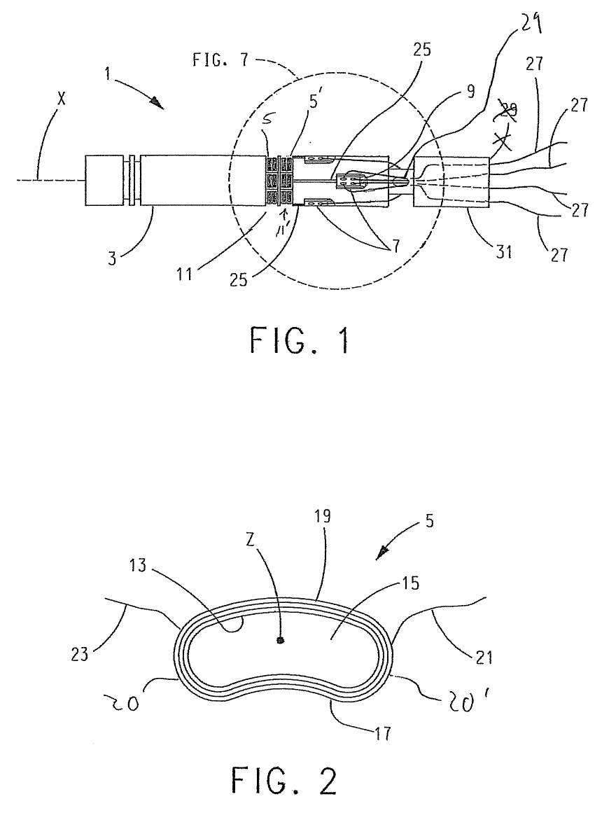

With reference to FIG. 2, and with continuing reference to FIG. 1, each kidney-shaped coil of wire 5, 5′ defines an axis Z about which an interior surface 13 of the coil of wire 5, 5′ defines an arcuate shaped central aperture 15 and about which axis Z an exterior surface of coil of wire 5, 5′ defines an arcuate or kidney-shaped inner radius 17 and an arcuate or kidney-shaped outer radius 19. Arcuate shaped inner radius 17 and arcuate shaped outer radius 19 of each coil of wire 5, 5′ extend between opposite ends 20, 20′ of coil of wire 5, 5′. Each coil of wire 5, 5′ further includes a first end 21 and a second end 23. Ends 21, 23 of each coil of wire 5, 5′ are configured to extend through one of a plurality of channels 25 to recess 9 where ends 21, 23 are operatively coupled to PCB 7 disposed in recess 9. Each coil of wire 5, 5′ may be formed of magnet wire made of approximately 99% copper. The magnet wire further includes an alcohol or heat activated bonding agent that allows the magnet wire to keep its shape after it has been wound. The number of turns of each coil of wire 5, 5′ can be selected in any suitable and/or desirable manner. In one non-limiting embodiment, each coil of wire 5, 5′ has 200 turns of wire.

With continued reference to FIG. 1, each coil of wire 5, 5′ is mounted in circumferential slots 11, 11′ with inner radius 17 of each coil of wire 5, 5′ facing longitudinal axis X of elongated body 3 and with outer radius 19 of each coil of wire 5, 5′ facing away from longitudinal axis X of elongated body 3. The set of coils of wire 5 are mounted in end-to-end relation in circumferential slot 11 with end 20 of one coil of wire 5 positioned next to or touching end 20′ of an adjacent coil of wire 5. The set of coils of wire 5′ are mounted in end-to-end relation in circumferential slot 11′ with end 20 of one coil of wire 5′ position next to or touching end 20′ of an adjacent coil of wire 5′. Eddy current probe 1 further includes a plurality of wires 27. Each wire 27 is connected to one of ends 21, 23 of one of the coils of wire 5, 5′ via PCB 7. Each wire 27 is then passed through an opening 29 formed in elongated body 3 that runs inside elongated body 3 to a first end 31 of body 3. PCB 7 is operative as an interface for connecting the ends 21, 23 of each coil of wire 5, 5′ to sensing circuitry via wires 27, as will be discussed in greater detail hereinafter.

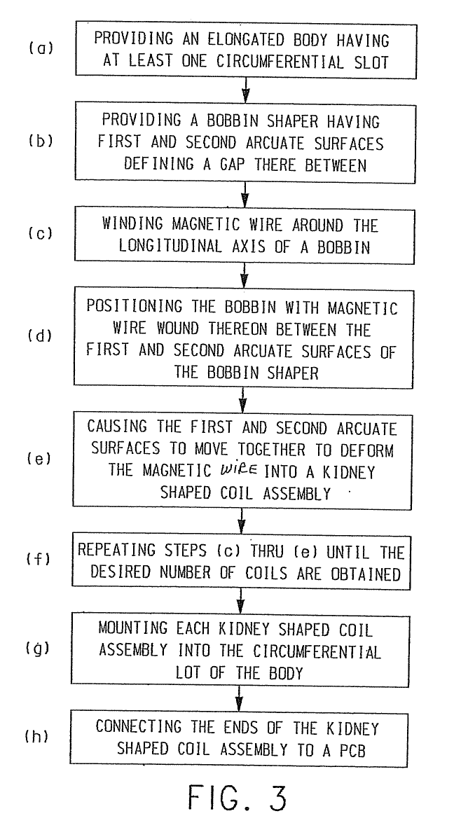

With reference to FIGS. 3-8, and with continuing reference to FIGS. 1 and 2, a method of manufacturing eddy current probe 1 will now be described. First, at step (a), elongated body 3 having circumferential slots 11, 11′ is provided. In one exemplary, non-limiting embodiment, elongated body 3 is formed from a non-magnetic and non-conductive material, such as nylon or acetal.

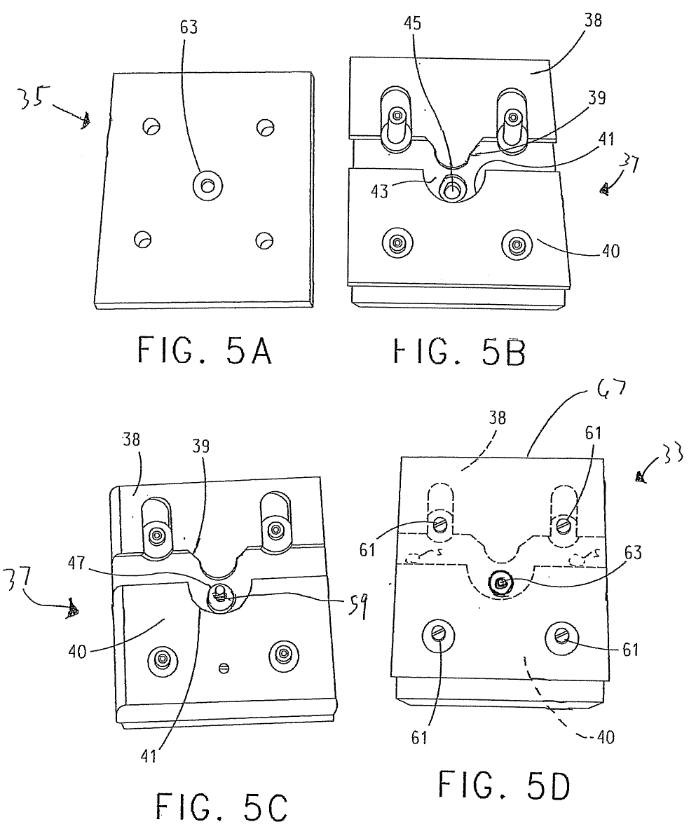

Thereafter, at step (b), a bobbin shaper, denoted generally as reference numeral 33 in FIG. 5D, is provided. Bobbin shaper 33 includes a top cover portion 35 (shown in FIG. 5A) and a bottom portion 37 (shown in FIG. 5B). Bottom portion 37 includes a slidable plate 38 having a first arcuate surface 39 and a fixed plate 40 having a second arcuate surface 41 positioned in spaced relation with first arcuate surface 39 to define an arcuate gap 43 therebetween. Bottom portion 37 also includes a recess 45 positioned between first arcuate surface 39 and second arcuate surface 41 configured to receive a bobbin assembly 47 with wire wound thereon. Bobbin shaper 33 is operative for changing a distance between the first and second arcuate surfaces 39, 41 as will be discussed in greater detail hereinafter.

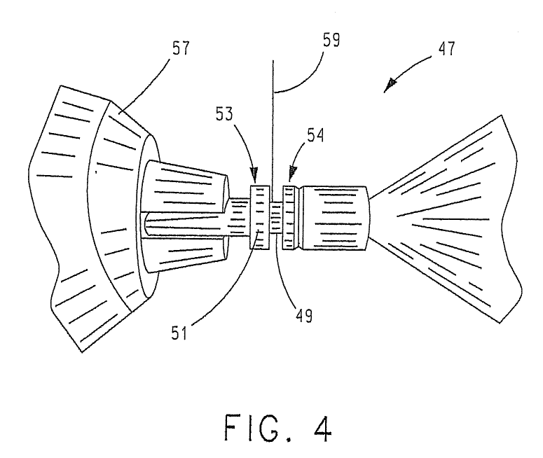

Next, at step (c) and with specific reference to FIG. 4, each initially unshaped coil of wire 5 is formed using the following steps. First, a bobbin assembly 47 is provided. Bobbin assembly 47 includes a jig body 51, a first side shield 53 coupled to a first end of the jig body 51, a bobbin 49 that defines a longitudinal axis extending from first side shield 53 and a second side shield 55 extending from bobbin 49. Then, bobbin assembly 47 is positioned in a winding chuck 57 and an end of a spool of magnet wire 59 is coupled to bobbin 49. Magnet wire 59 is thereafter evenly wound around the longitudinal axis of bobbin 49 for a predetermined number of turns. Either alcohol or heat is applied to magnet wire 59 during the winding process in order to activate a bonding agent. Once magnet wire 59 has been wound around bobbin 49 for the predetermined number of turns, the coil is either saturated with alcohol, or heat is applied thereto. Thereafter, magnet wire 59 is cut from the spool and bobbin assembly 47 is removed from winding chuck 57.

With reference to FIG. SC and at step (d), bobbin assembly 47, with magnet wire 59 wound thereon, is positioned in recess 45 of bottom portion 37 of bobbin shaper 33 such that the wound magnet wire 59 is positioned between first and second arcuate surfaces 39, 41 of slidable plate 38 and fixed plate 40, respectively, of bottom portion 37. Top cover portion 35 is then coupled on top of bottom portion 37 using fastening mechanisms 61 to form an assembled bobbin shaper 33 as shown in FIG. SD. Next, the portion of bobbin assembly 47 that supports wound magnet wire 59 is removed by placing a dowel pin (not shown) into opening 63 in top cover portion 35 of bobbin shaper 33 and applying pressure thereto. Thereafter, bobbin shaper 33 is placed within a vice (not shown) with a top end 67 thereof facing up. A C-clamp (not shown) is then placed around bobbin shaper 33 to insure that no gap exists between top cover portion 35, plates 38 and 40 and bottom portion 37. Next, a first stop S (shown in phantom in FIG. 5D) and a second stop S (shown in phantom in FIG. SD) are positioned within bobbin shaper 33 as shown in FIG. 5D. The first stop S and second stop S are configured to prevent the movement of slidable plate 38 of bottom portion 37 of bobbin shaper 33 after it has traveled a desired distance toward fixed plate 40.

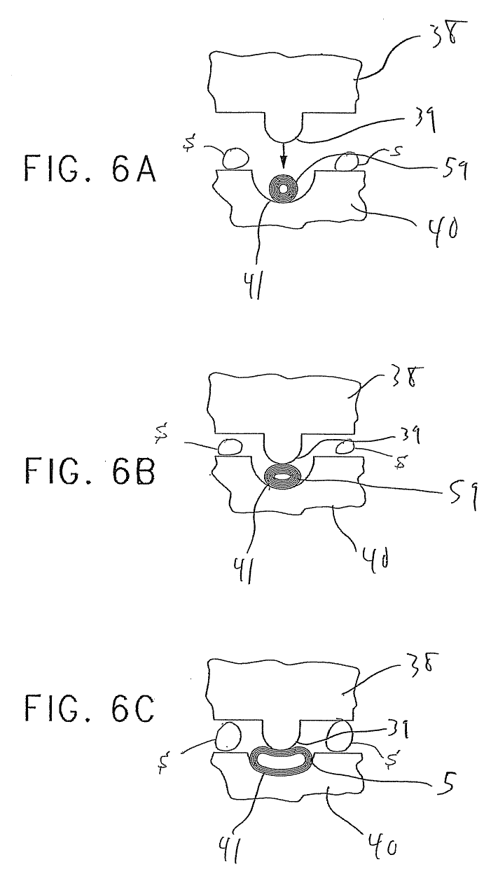

With reference to FIGS. 6A-6C, slidable plate 38 is moved toward fixed plate 40 until the first stop S and the second stop S are reached, thereby causing first and second arcuate surfaces 39, 41 to move together and deform magnet wire 59 into kidney-shaped coil of wire 5 or 5′. Bobbin shaper 33 is then removed from the vice and top cover portion 35 is removed therefrom. Kidney-shaped coil of wire S is then removed from between arcuate surfaces 39 and 41. Next, at step (f), steps (c) through (e) are repeated until the desired number of kidney-shaped coils of wire 5 or 5′ is obtained. Each coil of wire 5 is the same as each coil of wire 5′.

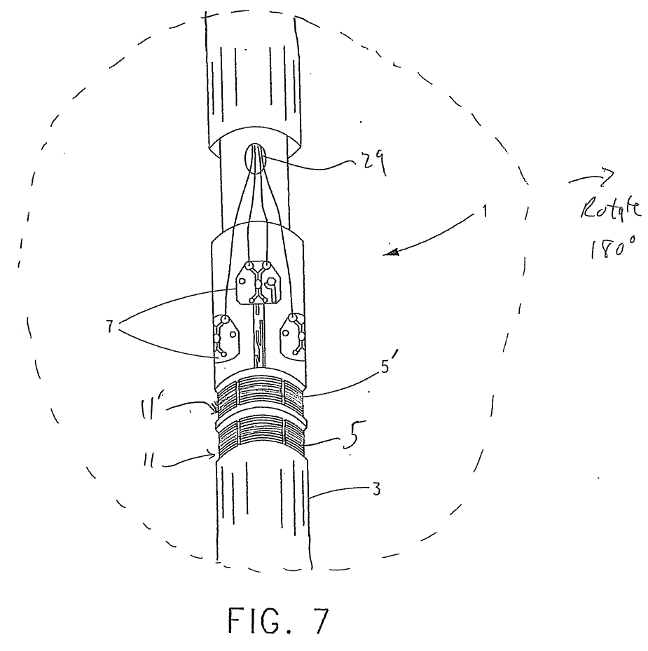

With reference to FIG. 7 and at step (g) each kidney-shaped coil of wire 5, 5′ is mounted in circumferential slots 11, 11′, respectively, of body 3 of eddy current probe 1 in an end-to-end relation such that inner radius 17 of each kidney-shaped coil of wire 5, 5′ faces into slot 11 and outer radius 19 thereof faces away from slot 11. Kidney-shaped coils of wire 5, 5′ are mounted in slots 11, 11′ using the following steps. First, an adhesive is applied to each kidney-shaped coil of wire 5, 5′. Then, each kidney-shaped coil 5, 5′ is placed in circumferential slots 11, 11′, respectively, of body 3 of eddy current probe 1 as described above. Next, at step (h), ends 21, 23 of each kidney-shaped coil of wire 5, 5′ are positioned within a respective channel 25 and coupled to at least one PCB 7 disposed in a recess 9 in elongated body 3. Thereafter, external wires 27 are soldered to the at least one PCB 7. Wires 27 allow ends 21, 23 of each kidney-shaped coil of wire 5, 5′ to be connected to sensing circuitry 81 via the at least one PCB 7. An end of each external wire 27 is thereafter passed through an opening 29 in elongated body 3 that runs inside elongated body 3 and out of first end 31 thereof as shown in FIG. 1.

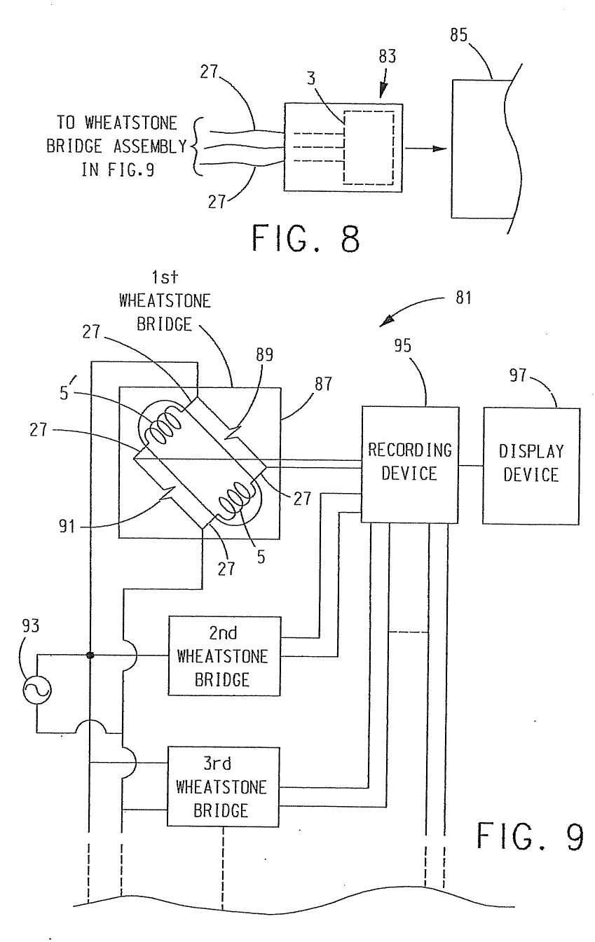

With reference to FIG. 8, and with continuing reference to FIGS. 1-7, elongated body 3 is then inserted into cover, denoted generally as reference numeral 83, thereby forming the final assembly of eddy current probe 1. Cover 83 covers and protects elongated body 3 and coils of wire 5, 5′ mounted thereon from environmental hazards. Desirably, cover 83 completely covers body 3 and coils of wire 5, 5′ mounted thereon. However, this is not to be construed as limiting the invention. In one exemplary, non-limiting embodiment, cover 83 is a sleeve formed of a non-magnetic material, such as stainless steel, having a wall thickness of about 0.015 inches. However, the use of stainless steel and the foregoing dimensions of cover 83 are not to be construed as limiting the invention.

In use, eddy current probe 1 is inserted into a tube 85 to be inspected by eddy current probe 1.

With reference to FIG. 9, and with continuing reference to FIGS. 1-8, at a suitable time, each coil of wire 5, 5′ on body 3 is coupled via its ends 21, 23 to at least one PCB 7 and then to external wire 27. External wires 27 are then coupled to the external sensing circuitry 81. More specifically, the ends of external wires 27 of each coil of wire pair 5, 5′ that are aligned parallel to longitudinal axis X of elongated body 3 are coupled to opposing legs of a Wheatstone Bridge 87 which has a pair of precision resistors 89 and 91 in the other legs thereof. Two opposing nodes of Wheatstone Bridge 87 are connected to an AC signal source 93 of suitable amplitude and frequency for testing tube 85. The other two nodes of Wheatstone Bridge 87 are connected to a recording device 95 which is operative for recording the time varying response of Wheatstone Bridge 87 to the AC signal output by AC signal source 93 in response to moving eddy current probe 1 through tube 85 in a manner known in the art. Specifically, each time a coil of wire pair 5, 5′ forming Wheatstone Bridge 87 encounters a flaw in tube 85, Wheatstone Bridge 87 outputs a corresponding signal to recording device 95. Recording device 95 can be any one of a strip chart recorder, a computer which can convert analog signals output by Wheatstone Bridge 87 into corresponding digital signal equivalents which can be processed and/or stored for subsequent retrieval and analysis, and the like. Where recording device 95 is a computer, a suitable display device 97 can be coupled to recording device 95 which can be operative for causing the output of Wheatstone Bridge 87 to be displayed on display device 97 as a function of time and/or as a function of the distance eddy current probe 1 travels in tube 85.

As shown in FIG. 9, a plurality of Wheatstone Bridges, each of which can be coupled to a different pair of coils of wire 5, 5′ of eddy current probe 1, can be coupled to recording device 95 which can be operative for recording the output of each Wheatstone Bridge 87 and, if desired, causing a display of the output versus time and/or versus position of eddy current probe 1 in tube 85 to be displayed on display device 97.

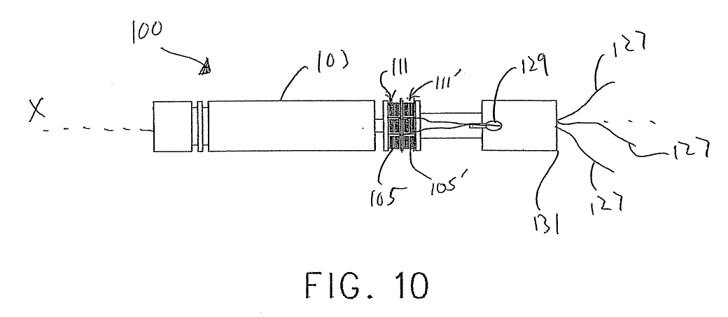

With reference to FIG. 10, an alternate embodiment eddy current probe 100 includes an elongated body 103 defining a longitudinal axis X, a plurality of kidney-shaped coils of wire 105, 105′ mounted on elongated body 103. A pair of circumferential slots 111, 111′ for receiving kidney-shaped coils of wire 105, 105′, respectively, is formed in elongated body 103 intermediate the ends of elongated body 103. Circumferential slots 111, 111′ face away from longitudinal axis X. In this embodiment, the printed circuit boards of eddy circuit probe 1 are excluded and external wires 127 are soldered directly to the ends of kidney-shaped coils of wire 105, 105′. An end of each external wire 127 is thereafter passed through an opening 129 in elongated body 103 that runs inside elongated body 103 to a first end 131 of body 103. External wires 127 are thereafter connected to sensing circuitry 81.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. An eddy current probe comprising:
an elongated body defining a longitudinal axis;
at least one circumferential slot in said elongated body intermediate the ends of said elongated body, each circumferential slot facing away from said longitudinal axis;
a plurality of coils, each coil defining an axis about which an interior surface of the coil defines an arcuate shaped central aperture of the coil and about which axis an exterior surface of the coil defines an arcuate shaped inner radius and an arcuate shaped outer radius, wherein the arcuate shaped inner radius and the arcuate shaped outer radius of each coil extend between opposite ends of said coil, each coil is mounted in the slot with the inner radius of said coil facing the longitudinal axis of said elongated body, with the outer radius of said coil facing away from the longitudinal axis of said elongated body, and said plurality of coils are mounted in end-to-end relation in the slot; and
a printed circuit board mounted in a recess in said elongated body, said printed circuit board operative as an interface for connecting the ends of each coil to sensing circuitry.

2. The eddy current probe of claim 1, wherein the elongated body is electrically and magnetically non-conductive.

3. The eddy current probe of claim 1, further comprising a cover covering the elongated body and the plurality of coils mounted thereon.

4. The eddy current probe of claim 3, wherein the cover is formed from a magnetically non-conductive material.

5. A method of making an eddy current probe comprising:
(a) providing an elongated body that defines a longitudinal axis and which includes at least one circumferential slot intermediate the ends of said elongated body that faces away from the longitudinal axis;
(b) providing a bobbin shaper having first and second arcuate surfaces positioned in spaced relation to define an arcuate gap therebetween, wherein the bobbin shaper is operative for changing a distance between the first and second arcuate surfaces;
(c) for each of a plurality of bobbins that defines a longitudinal axis, winding magnet wire on the bobbin around the longitudinal axis;
(d) for each bobbin with magnet wire wound thereon positioned between the first and second arcuate surfaces of the bobbin shaper, causing the first and second arcuate surfaces to move together and deform the bobbin with magnet wire wound thereon into a kidney-shaped coil of wire about the longitudinal axis of the bobbin; and
(e) mounting each kidney-shaped coil of wire in the circumferential slot of the body in end-to-end relation, with an inner radius of each kidney-shaped coil of wire facing into the slot and with the outer radius thereof facing away from the slot.

6. The method of claim 5, further comprising connecting the ends of each kidney-shaped coil of wire to sensing circuitry, either directly or via a printed circuit board disposed in a recess in said elongated body.

7. The method of claim 5, further comprising inserting the elongated body with the kidney-shaped coils of wire mounted thereon into a cover.

8. The method of claim 7, wherein the cover is formed from a magnetically non-conductive material.

9. The method of claim 5, wherein the elongated body is formed from an electrically and magnetically non-conductive material.

10. An eddy current probe comprising:
a plurality of kidney-shaped coils disposed in end-to-end relation about an axis of an elongated body, with an inner radius of each kidney-shaped coil facing the axis and with an outer radius of each kidney-shaped coil facing away from the axis; and
a plurality of wires, each of which is connected to one of the ends of one of the kidney-shaped coils via an opening in the body that runs inside the body from one end of the body to a position intermediate the one end of the body and the kidney-shaped coils.

11. The eddy current probe of claim 10, wherein a side wall of the body has a reduced circumference where the end of the opening opposite the one end of the body is located.

12. The eddy current probe of claim 10, further comprising a printed circuit board mounted on said elongated body with the ends of each kidney-shaped coil connected thereto, with the one end of each wire connected to the corresponding end of one of the kidney-shaped coils via the printed circuit board.

13. The eddy current probe of claim 12, wherein the printed circuit board is operative as an interface for connecting the ends of each coil to sensing circuitry.

14. The eddy current probe of claim 10, further comprising a cover covering the body and the plurality of kidney-shaped coils disposed thereon.

15. The eddy current probe of claim 14, wherein the cover is formed from a magnetically non-conductive material.

16. The eddy current probe of claim 10, wherein the body is formed from an electrically and magnetically non-conductive material.
